(19) United States
(12) Patent Application Publication
(10) Pub. No.: US 2014/0181982 A1
(43) Pub. Date: Jun. 26, 2014

(54) METHOD AND SYSTEM FOR DATA PROTECTION

(71) Applicant: EMC Corporation, Hopkinton, MA (US)

(72) Inventors: Feng Guo, Shanghai (CN); Qiyan Chen, Shanghai (CN); Deming Shi, Shanghi (CN); Jun Tao, Shanghai (CN); Tianqing Wang, Shanghai (CN)

(73) Assignee: EMC Corporation, Hopkinton, MA (US)

(21) Appl. No.: 14/109,030

(22) Filed: Dec. 17, 2013

(30) Foreign Application Priority Data
Dec. 20, 2012 (CN) CN201210595747.7

(51) Int. Cl. G06F 21/57

(52) U.S. Cl. CPC G06F 21/577
USPC 726/25

(57) ABSTRACT

Embodiments of the present invention relate to a method and system for data protection. A data protection method comprises: receiving at least one event prediction message from at least one message source, the at least one event prediction message being associated with an event that is predicted to occur in a future period of time; analyzing information, which is relevant to the event, included in the at least one event prediction message, so as to determine a risk level of the event with respect to the data to be protected; and determining a data protection operation at least based on the risk level and a predetermined event handling policy. There is further disclosed a corresponding data protection system. According to the embodiments of the present invention, it is enabled to voluntarily, dynamically, and flexibly handle high-risk events potentially damaging data, thereby better guaranteeing data security.

### FIELD OF INVENTION

Embodiments of the present invention generally relate to data security, and more specifically, to a method and system for data protection.

### BACKGROUND OF INVENTION

Data protection is an important measure to guarantee data security, integrity and/or consistency, which is crucial in environments such as data center. A common data protection for example comprises data backup and data transfer, as well as maintenance and repair of a data storage device, etc. For various kinds of data protection automatically executed by a machine, generally a dedicated person (for example, an administrator) first formulates a data protection plan based on factors such as data availability demand and business sustainability. Then, an appropriately configured application responsible for data protection (hereinafter referred to as a “data protection application”) may perform protection operations on the data to be protected according to a formulated data protection plan during an appropriate period of time, for example, backing up some or all of the data.

Such predefined data protection plan is static and short of flexibility and intelligence in processing dynamic environments and emergent events. For example, without human intervention, the data protection application cannot execute an appropriate data protection action to handle some emergent high-risk events, for example, extreme whether (typhoon, rain storm, snow storm), geological disaster (mud avalanche), human activities (power breakdown, physical server maintenance), etc. It would be appreciated that among these high-risk events, some are unpredictable, while some others may be predictable or forecasted.

However, the existing data protection systems are completely dependent on static and predetermined data protection plans. Once the administrator fails to modify the data protection plans in time due to various reasons such as human negligence, force majeure, etc, it is possible that data service interruption or even permanent loss of data would be incurred, even if these high-risk events per se are predictable.

Therefore, in the present field, it is desirable for a data protection method and system capable of dynamically and effectively handling predictable risk events.

### SUMMARY OF INVENTION

In view of the above problems, embodiments of the present invention provide a dynamic data protection method and system.

According to a first aspect of the present invention, there is provided a data protection method. The data protection method comprises: receiving at least one event prediction message from at least one message source, the at least one event prediction message being associated with an event that is predicted to occur in a future period of time; analyzing information, which is relevant to the event, included in the at least one event prediction message, so as to determine a risk level of the event with respect to the data to be protected; and determining a data protection operation at least based on the risk level and a predetermined event handling policy.

According to another aspect of the present invention, there is provided a data protection system. The data protection system comprises: a receiving unit configured to receive at least one event prediction message from at least one message source, the at least one event prediction message being associated with an event that is predicted to occur in a future period of time; an analyzing unit configured to analyze information, which is relevant to the event, included in the at least one event prediction message, so as to determine a risk level of the event with respect to the data to be protected; and a decision unit configured to determining a data protection operation at least based on the risk level and a predetermined event handling policy.

It will be understood through the following description that according to the embodiments of the present invention, it is enabled to automatically and adaptively add or update a data protection plan based on a message obtained from various message sources and indicating a high-risk event that will potentially occur. In this way, it is enabled to effectively reduce potential damages incurred to the data from these predictable high-risk events.

### BRIEF DESCRIPTION OF DRAWINGS

Through the following detailed description with reference to the accompanying drawings, the above and other objectives, features and advantages of the embodiments of the present invention will become more comprehensible. In the accompanying drawings, several embodiments of the present invention are illustrated in an exemplary, not limiting, manner, wherein:

FIG. 1 shows a flowchart of a data protection method according to one exemplary embodiment of the present invention;

FIG. 2 shows a flowchart of a data protection method according to another exemplary embodiment of the present invention;

FIG. 3 shows a block diagram of a data protection system according to one exemplary embodiment of the present invention; and

FIG. 4 shows a block diagram of a computer suitable for implementing the embodiments of the present invention.

In each figure, same or corresponding numbers indicate same or corresponding parts.

### DETAILED DESCRIPTION OF EMBODIMENTS

Hereinafter, the principle and spirit of the present invention will be described with reference to a plurality of exemplary embodiments illustrated in the figures. It should be understood that these embodiments are merely given to enable those skilled in the art to better understand and further implement the present invention, instead of limiting the scope of the present invention in any manner.

The basic idea of the embodiments of the present invention is to dynamically obtain a message indicating a predictable high-risk event, and judge a risk level of an immediately occurring event with respect to the data to be protected based on the above message, so as to dynamically and adaptively add or adjust a data protection plan and respond appropriately to a potentially occurring high-risk events. In this way, it is enabled to effectively prevent damages to the data from such high-risk events.

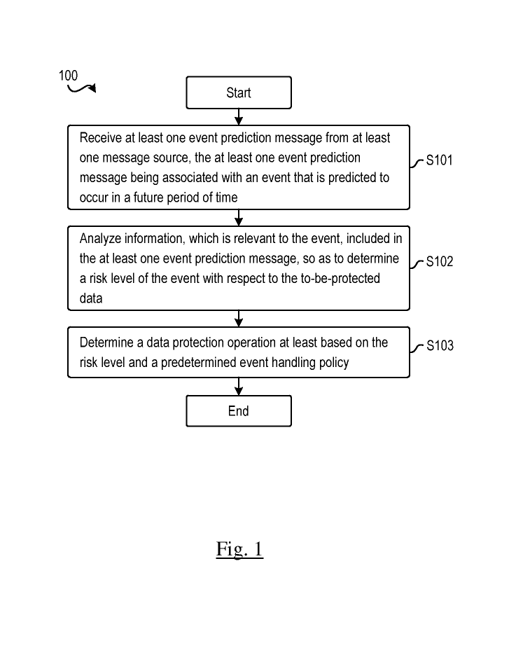

First, with reference to FIG. 1, it illustrates a flowchart of a data protection method according to one exemplary embodiment of the present invention. The method 100 is performed for example by a data protection application.

After the method 100 starts, in step S101, at least one event prediction message is received from at least one message source, the at least one event prediction message being associated with an event that is predicted to occur in a future period of time.

According to the embodiments of the present invention, the message source may be any entity capable of providing a prediction or forecast of a future event. The message source, for example, may be an information system in a Meteorological Administration, an Earthquake Administration, a government department, a maritime department, or any party capable of providing a prediction of such events. The message source may predict a high-risk event likely to occur in one or more time periods in the future, for example, a rain storm, a cyclone, other extreme weathers, tsunami, geological disasters, municipal engineering, power shutdown, disruption of computer viruses, network attack against data, etc. Generally, the term “high-risk event” as used here refers to an event that has a higher risk level with respect to the data to be protected, i.e., an event that might cause data service interruption and/or data loss, which not only comprises a physical event occurring in a real world, but also comprises a virtual event (for example, a computer virus, network attack). A high-risk event may be predicted by any existing or future developed technology, which is not the focus of the present invention and does not constitute a limitation of the present invention either.

When the high-risk event is predicted, the message source side may generate a message indicating the event and its relevant information, i.e., the “event prediction message” mentioned in step S101, in an information manner (for example, by means of an electronic device such as a computer). According to the embodiments of the present invention, the event prediction message may be a message in any appropriate format. For example, some event prediction messages may be in a textual form, describing an event with a human readable format (for example, a natural language). An example of such event prediction message may be “XX year, YY month, ZZ day, rain storm weather will occur in A area, lasting about 2 hours, with a predicted rainfall of XX mm”. In some other embodiments, the event prediction message may be a message in a machine-readable format, for example, a message encoded or formatted in a binary system or in other manner. The format and type of the event prediction message will be detailed hereinafter, and the scope of the present invention is not limited there to.

According to the embodiments of the present invention, the event prediction message received in step S101 comprises information relevant to the event, for example, including, but not limited to: event type (for example, “geological disaster,” “extreme weather,” “social behavior,” “virtual event,” etc.), event description (for example, description of parameters such as rainfall, wind speed, etc.), predicted occurring time of the event, predicted lasting time or predicted end time of the event, and predicted impact scope of the event (for example, geographic region), etc. Dependent on different message sources, the event prediction message may comprise other additional or alternative information, and the scope of the present invention is not limited thereto.

According to the embodiments of the present invention, one or more message sources and the data protection application may communicate with each other by various kinds of communicating means, for example, a computer network, a communications network, etc. Different message sources may communicate with the data protection application by various different means.

According to the embodiments of the present invention, in step S101, the event prediction message may be periodically received from the message source. In other words, the event prediction message may be pulled from the message source in an active manner. According to some embodiments, the period for receiving the event prediction message from the message source may be configurable. Alternatively or additionally, the event prediction message may be received in a passive manner in response to a push of the message source. For example, after the event prediction message is generated, the message source may send the message to the data protection application in a manner similar to interruption.

Next, the method proceeds to step S102 to analyze the information relevant to the event and contained in the event prediction message received in step S101, to determine a risk level of the event with respect to the data to be protected.

According to the embodiments of the present invention, the data to be protected for example may be pre-appointed. At this point, the method according to the embodiments of the present invention is equivalent to a process dedicated to a particular data (for example, data stored in an appointed location). Alternatively or additionally, the data to be protected may also be determined dynamically. For example, a system or apparatus for data protection (i.e., the executing body for the method described here) is likely responsible for protecting data that are stored geographically separately (for example, data stored in different machines or even different cities). At this point, if the event relevant information received in step S101 contains the predicted impact scope of the event, then which data might be affected by the immediately occurring event can be dynamically determined based on the storage location of the data and the impact scope, i.e., dynamically determining the data to be protected.

According to the embodiments of the present invention, different risk levels may be pre-set for various kinds of potentially occurring events, i.e., establishing a correlation relationship between an event and a risk level. As an example, numerical values within a certain range (for example, integers within the range of 1-10) may be used to indicate the risk levels of events, for example, a larger numerical value indicates a higher risk level (or vice versa). Only as an example, the following table illustrates a predetermined correlation between an event and a risk level.

| Event | Risk Level |
|---|---|
| Typhoon | 8 |
| Rain storm | 6 |
| Snow storm | 7 |
| Tsunami | 10 |
| Power shutdown | 4 |
| Data server maintenance | 2 |
| . . . | . . . |

Therefore, in step S102, a risk level of an event may be determined based on the above correlation relationship and in accordance with the information relevant to the event and carried in the event prediction message. Note, the above table is merely exemplary. For example, in some alternative embodiments, the risk levels of high-risk events may be described qualitatively, instead of quantitatively, for example, “extremely high,” “very high,” “medium,” “relatively low,” “low,” or “red,” “orange,” “yellow,” etc. All of the above are merely exemplary, and the present invention is not limited thereto.

According to some other embodiments of the present invention, it might not be the case of determining a risk level for each specific event, but classifying the events, and then determining a threatening state based on the class of an event. For example, the events may be categorized into different classes, such as “meteorological class,” “geologic class,” “human activity class,” etc. Correspondingly, the class to which an event predicted to occur immediately may be determined through the relevant information contained in the event, and then the risk level of the event is determined based on the correlation relationship between the class and the risk level.

Particularly, the risk level of the event may vary dynamically with time. That is, the correlation relationship between an event and a risk level can be configured and adjusted. The correlation relationship between an event and a risk level may be adjusted and updated by a human user. Alternatively or additionally, it may also be automatically learned and implemented based on the historical records of damages caused by various events to the data. For example, if it was previously deemed that the rain storm has a low threatening level to data, but with the elapse of time, it is found that when rain storm weather occurs, data loss might be caused due to server shutdown induced by device short circuit, then the risk level correlated to the “rain storm” event can be correspondingly raised.

Besides, according to the embodiments of the present invention, the risk level of an event is also related to a current state of the data to be protected. For example, for a same event, the risk level of the event might be different depending on various factors such as the geographical location of the data server, the physical solid degree of the data server, the risk-resistance level of the building where the data server is located, and whether a backup power supply is present, etc.

According to an alternative embodiment of the present invention, the risk level of an event may also be indicated directly by the message source in the event prediction message. In this case, in step S102, the executing party of the method 100 (for example, the data protection application) needs not voluntarily determining the risk level, but directly extracts the information indicating the risk level of the event from the event prediction message as received in step S101. Other manners of determining the risk level of the event with respect to the data to be protected are also feasible, all of which fall within the scope of the present invention.

The method 100 proceeds to step S103, where an appropriate data protection operation is determined at least based on the risk level as determined in step S102 and a predetermined event handling policy. Here, the term “event handling policy” refers to data protection guidelines or specifications that prescribe how to handle and respond to various events. The event handling policy for example may be stored in any appropriate repository that is accessible to the data protection application.

The event handling policy may be defined for example by an administrator or other user. Alternatively or additionally, the event handling policy may also be obtained through dynamical learning based on the previous data protection historical metadata. The event handling policy prescribes the correlation relationships between different risk levels and different data protection operations. For example, in an embodiment where the event risk level is represented quantitatively by a numerical value, the event handling policy may prescribe the correlations between each risk level value and different data protection operations. For example, an exemplary event handling policy represented by a pseudo code may be:

```
IF (risk level < 3)
  THEN execute a local backup of a particular portion of the data;
ELSE
  IF (risk level < 7)
  THEN execute a remote backup of a particular portion of the data;
  ELSE execute a remote backup of all data and temporarily suspend data
  service.
```

For another example, in an embodiment of qualitatively representing an event risk level, the event handling policy for example may be defined as: for an event of a relatively low risk level (for example, “yellow”), executing backup of a part of data; for an event of a medium risk level (for example, “orange”), executing remote backup of a part of data; and for an event of a high risk level (for example, “red”), executing remote backup of all data and temporarily closing up the data service, etc.

In particular, it may be seen in that step S103 merely considers the risk level of the event and the predetermined event handling policy to determine the data protection action. In such embodiment, the determined data protection operation may be executed immediately. Alternatively, according to other embodiments of the present invention, other affecting factors may also be considered to thereby determine appropriate execution timing for the data protection operation, which will be detailed later.

Besides, according to the embodiments of the present invention, it is not limited to execute the data protection operation determined in step S103 once. On the contrary, the corresponding data protection operation may be executed once or more times during the occurring period of the high-risk event. For example, it is executed once every particular period of time, or activated to execute at one or more appointed times. The scope of the present invention is not limited thereto.

Method 100 ends after step S103. Through performing method 100, an appropriate data protection operation may be dynamically determined based on an event prediction message from the message source, thereby adopting an automatic and adaptive responding action for a potentially occurring high-risk event. In this way, compared with merely depending on a pre-formulated static data protection policy, the present invention can guarantee data security more effectively.

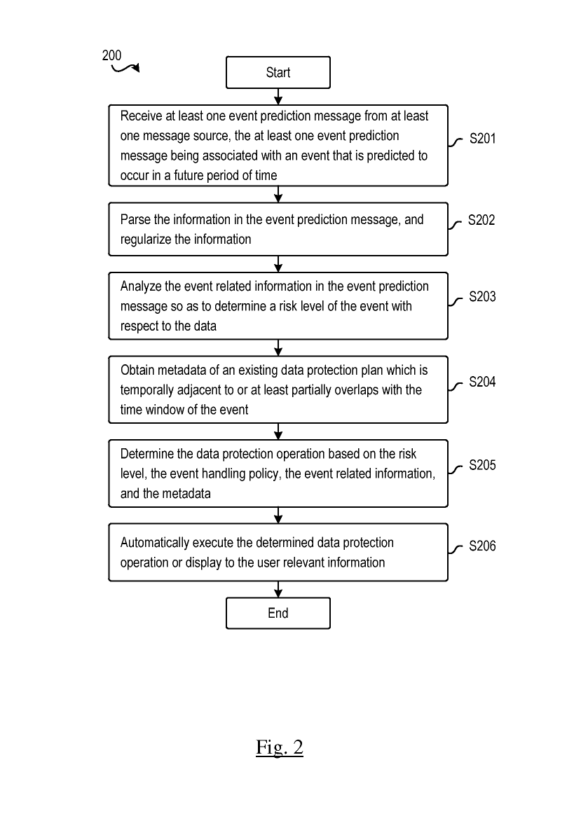

Hereinafter, referring to FIG. 2, it shows a flowchart of a data protection method according to another exemplary embodiment of the present invention. The method 200 as illustrated in FIG. 2 may be regarded as a particular implementation of the method 100 described above with reference to FIG. 1.

After the method 200 starts, in step S201, at least one event prediction message is received from at least one message source. The step S201 corresponds to the step S101 as described above with reference to FIG. 1, which will not be detailed here.

Next, in step S202, information in the event prediction message is extracted and normalized. As above mentioned, the event prediction message at least may comprise one or more of the following information items: event type, event description, predicted occurring time of the event, predicted lasting time or predicted end time of the event, and predicted impact scope of the event. However, different message sources may adopt different formats to represent the above information, which causes inconvenience in subsequent processing. To this end, in step S202, these information items may be extracted after receiving the event prediction message and normalize these information items uniformly.

According to the embodiments of the present invention, extraction of information items for example may be executed based on any appropriate technical means. For example, if the event prediction message adopts a textual description manner to carry the event related information, a natural language understanding technology may be adopted to process this message and extract corresponding information content. For another example, if the message source adopts a predetermined format to encode the event related information, then information may be extracted from the event prediction message based on the priori knowledge about the encoding format, wherein the prior knowledge about the encoding format for example may be notified to the data protection application in advance by the message source.

Then the method 200 proceeds to step S203, where the event related information in the event prediction message is analyzed to determine a risk level of the event with respect to the data to be protected. In particular, as above mentioned, the data to be protected may be dynamically determined based on the predicted impact scope of the event and the storage location of the data. Step S203 corresponds to step S102 as above described with reference to FIG. 1; thus, its other aspects will not be detailed. In particular, because the event related information has been normalized in step S202, the processing in step S203 can be performed more effectively.

Next, in step S204, metadata of an existing data protection plan for the data to be protected is obtained, wherein the existing data protection plan is temporally adjacent to or at least partially overlaps with the time period in which the event will occur. It may be seen from the above description that in the event prediction message received from the message source, the predicted occurring time as well as the predicted receiving time and/or predicted lasting time of the event may be contained. In such embodiment, it may be determined whether an existing data protection plan, which is temporally adjacent to or at least partially overlaps with the time period in which the event will occur, is present by accessing the metadata for example associated with the data protection application. If such data protection plan is present, then the metadata of this or these data protection plans may be obtained. The metadata at least may indicate the start time of the corresponding data protection plan, the specific data protection operation to be executed, execution timing or frequency, and other relevant information.

Next, in step S205, a data protection action may be determined based on the risk level of the event, the predetermined event handling policy, event related information, and metadata. It may be seen that compared with the step S103 as above described with reference to FIG. 1, in this embodiment, the event related information and the metadata of the existing data protection plan may also be considered when determining the data protection action, which, for example, may determine the data protection operation per se and the executing timing of the data protection operation in a better way.

Specifically, for example, it may be decided whether the existing data protection plan suffices to at least partially guarantee data security within the time period when the event will occur. The deciding result may be used when determining the data protection operation. Consider a specific example. Suppose the event prediction message indicates that power shutdown will occur during the period [t1, t2] (t1 and t2 indicate the start time and end time of the period, respectively), and determine, based on the metadata, a data protection plan of remotely backing up all data at time t3 before time t1, wherein t1 and t3 has a sufficiently close interval therebetween, then in step S205, the following data protection operation may be determined: merely back up the data changing between the period [t3, t1]. In other words, at this point, it is only needed to perform “differential” protection to the data.

For another example, if another data protection policy plans to maintain the physical server, the execution period of the maintenance at least partially overlaps with the period [t1, t2], and the maintenance action might cause data loss in the case of occurrence of a high-risk event, then in step S205, the following data protection operation may be determined: cancel or postpone the existing data protection plan or change some operations for maintaining the physical server. In other words, the data protection operation as determined in step S205 may comprise modifying or updating the data protection operation to be executed to the existing data plan.

Alternatively, according to some other embodiments of the present invention, the event handling policy may be modified according to the existing data protection plan, instead of changing the existing data protection plan, so as to avoid adverse impact on the existing data protection plan. For example, suppose when a particular event A will occur, a common event handling policy is to perform local backup once during the period [t1, t2]. However, if it is found that for the data to be protected, an existing data protection plan to be executed during the period [t3, t4] (t1<t3<t2) is present, and executing the local backup during the period [t1, t2] might cause adverse impact on or a confliction with the existing data protection plan, then the embodiments of the present invention allow dynamically modifying the event handling policy so as to avoid such conflict when determining the data protection operation. For example, the modification of the event handling policy may comprise: changing the execution period for the data protection operation from [t1, t2] to other period, and/or change the data protection operation per se. Or, a potential confliction may be displayed to the user such that the user manually determines how to continue.

The data protection operation determined in step S205 may further comprise a supplementation to the existing data protection plan. For example, if the event prediction message indicates that a new computer virus may break out in the Internet during the period [t1, t2], then in step S205, a patch or virus database for the virus may be obtained through an appropriate operation and added to the existing virus scan application. Correspondingly, the executing timing of the virus scan application may be set appropriately.

Further, as an exceptional example, if an existing data protection plan is already present and suffices to guarantee data security for the event to occur during the period [t1, t2], then in step S205, it may be determined not to perform any other additional operation.

Finally, in step S206, the data protection operation as determined in step S205 may be automatically executed. Alternatively or additionally, information related to the high-risk event to occur and/or the determined data protection operation may also be displayed to the user such as an administrator. The user may view and/or modify the data protection operation through an interactive interface such as a graphical user interface (GUI).

The method 200 ends after step S206.

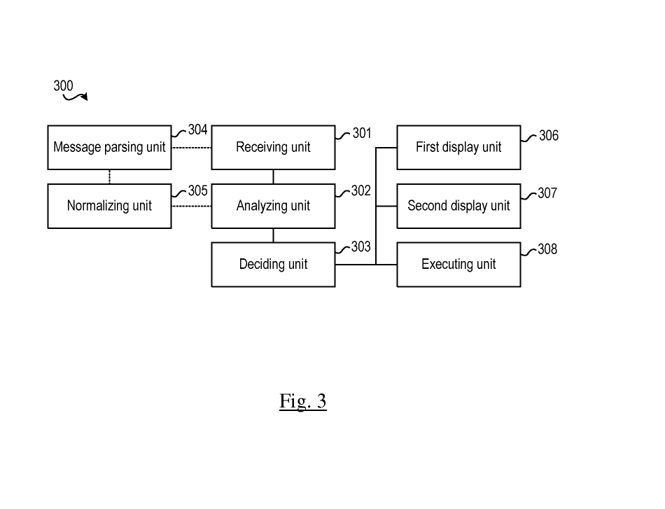

Hereinafter referring to FIG. 3, FIG. 3 shows a block diagram of a data protection system 300 according to the exemplary embodiments of the present invention. As shown in the figure, according to the embodiments of the present invention, the data protection system 300 comprises: a receiving unit 301 configured to receive at least one event prediction message from at least one message source, the at least one event prediction message being associated with an event that is predicted to occur in a future period of time; an analyzing unit 302 configured to analyze information, which is relevant to the event, included in the at least one event prediction message, so as to determine a risk level of the event with respect to the data to be protected; and a decision unit 303 configured to determining a data protection operation at least based on the risk level and a predetermined event handling policy.

According to some embodiments of the present invention, the receiving unit 301 comprises at least one of the following: a first receiving unit configured to periodically receive the at least one event prediction message from the at least one message source; and a second receiving unit configured to receive the at least one event prediction message in response to push from the at least one message source.

According to some embodiments of the present invention, the information related to the event comprises at least one of the following items: type of the event, description of the event, predicted occurring time of the event, predicted lasting time or predicted end time of the event, and predicted impact scope of the event.

According to some embodiments of the present invention, the information related to the event comprises the predicted impact scope of the event, and the data protection system 300 may further comprise: a data determining unit (not shown) configured to automatically determine the data to be protected based on the storage location of the data and the predicted impact scope.

According to some embodiments of the present invention, the data protection system 300 may further comprise the following alternative units: a message parsing unit 304 configured to parse the information related to the event from among the at least one event prediction message; and a normalizing unit 305 configured to normalize the parsed information so as to be used for the analyzing.

According to some embodiments of the present invention, the analyzing unit 302 may comprise: a correlation query unit configured to query a predetermined correlation between an event and a risk level using the information related to the event; and a level determining unit configured to determine the risk level of the event based on the query.

According to some embodiments of the present invention, the deciding unit 303 comprises: metadata obtaining unit configured to obtain metadata of an existing data protection plan which is temporally adjacent to or at least partially overlaps with the period; and a first deciding unit configured to determine the data protection operation based on the risk level, the event handling policy, the information related to the event, and the metadata. According to some embodiments of the present invention, the first deciding unit may comprise a handling policy modifying unit configured to modify the event handling policy so as to avoid confliction with the existing data protection plan when determining the data protection operation.

According to some embodiments of the present invention, the data protection system 300 further comprises at least one of the following alternative units: a first display unit 306 configured to display information related to the determined data protection operation to the user; a second display unit 307 configured to display the information related to the event to the user, and an executing unit 308 configured to automatically execute the determined data protection operation.

It would be appreciated that the system 300 may act as the executing body for the methods 100 and 200 as above described with reference to FIGS. 1 and 2. Thus, various features as described above are likewise applicable to the system 300, which will not be detailed here.

Besides, according to the embodiments of the present invention, the data protection system 300 may be implemented in various manners. For example, in some embodiments, the data protection system 300 may be implemented using software. For example, the data protection system 300 may be implemented as one part of the data protection application or another software system that it can invoke. At this point, respective units comprised in the data protection system 300 may be implemented as software units.

Alternatively, the data protection system 300 may be partially or completely implemented based on hardware. For example, the data protection system 300 may be implemented as an integrated circuit (IC) chip or an application specific integrated circuit (ASIC), a field programmable gate array (FPGA), a system on chip (SOC), etc. At this point, the respective units in the data protection system 300 may be implemented as hardware-based units or elements. A device (for example, a pluggable card) comprising the hardware data protection system 300 may be coupled to a computer where the data protection application resides. Any other currently known or future developed manners are also feasible, and the scope of the present invention is not limited in this aspect.

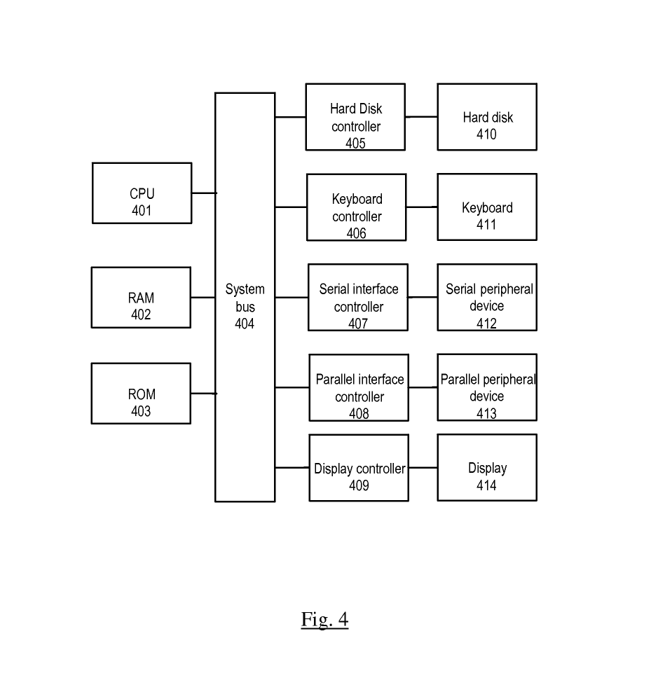

Hereinafter, referring to FIG. 4, FIG. 4 shows a schematic block diagram of a computer that is adapted to implement the embodiments of the present invention. As shown in FIG. 4, the computer 400 includes a CPU (Central Processing Unit) 401, a RAM (Random Access Memory) 402, a ROM (Read Only Memory) 403, a system bus 404, a hard disk controller 405, a keyboard controller 406, a serial interface controller 407, a parallel interface controller 408, a display controller 409, a hard disk 410, a keyboard 411, a serial peripheral device 412, a parallel peripheral device 413 and a display 414.Among these components, coupled to the system bus 404 are the CPU 401, the RAM 402, the ROM 403, the hard disk controller 405, the keyboard controller 406, the serial interface controller 407, the parallel interface controller 408 and the display controller 409. The hard disk 410 is coupled to the hard disk controller 405; the keyboard 411 is coupled to the keyboard controller 406; the serial peripheral device 412 is coupled to the serial interface controller 407; the parallel peripheral device 413 is coupled to the parallel interface controller 408; and the display 414 is coupled to the display controller 409. It should be understood that the structural block diagram in FIG. 4 is shown only for illustration purpose, and is not intended to limit the scope of the present invention. In some cases, some devices may be added or reduced as required.

As above mentioned, the data protection system 300 may be implemented through hardware, for example, chip, ASIC, FGPA, SOC, etc. Such hardware may be integrated or coupled into the computer 400. Besides, the embodiments of the present invention may also be implemented in a form of a computer program product. For example, the method 100 and method 200 as described with reference to FIG. 1 and FIG. 2 may be implemented via a computer program product. This computer program product may be stored, for example, in RAM 404, ROM 404, hard disk 410 and/or any suitable storage medium as illustrated in FIG. 4, or downloaded to the computer 400 from a suitable location via the network. The computer program product may comprise a computer code portion comprising a program instruction that may be executed through a suitable processing device (for example, CPU 401 in FIG. 4). The program instruction at least may comprise an instruction for implementing steps of the method 100 and the method 200.

It should be noted that, the embodiments of the present invention can be implemented in software, hardware or the combination thereof. The hardware part can be implemented by a special logic; the software part can be stored in a memory and executed by a proper instruction execution system such as a microprocessor or a design-specific hardware. The normally skilled in the art may understand that the above device and method may be implemented with a computer-executable instruction and/or contained in a processor controlled code, for example, such code is provided on a bearer medium such as a magnetic disk, CD, or DVD-ROM, or a programmable memory such as a read-only memory (firmware) or a data bearer such as an optical or electronic signal bearer. The apparatuses and their components in the present invention may be implemented by hardware circuitry such as a very large scale integrated circuit or gate array, a semiconductor such as logical chip or transistor, or a programmable hardware device such as a field-programmable gate array or a programmable logical device, or implemented by software executed by various kinds of processors, or implemented by combination of the above hardware circuitry and software, for example, firmware.

The communication network as mentioned in this specification may comprise various kinds of networks, including but not limited to local area network (“LAN”), wide area network (“WAN”), an IP-protocol based network (for example, Internet), and an end-to-end network (for example, ad hoc peer-to-peer network).

It should be noted that although a plurality of units or sub-units of the apparatuses have been mentioned in the above detailed depiction, such partitioning is merely non-compulsory. In actuality, according to the embodiments of the present invention, the features and functions of the above described two or more units may be embodied in one unit. In turn, the features and functions of the above described one unit may be further partitioned to be implemented in more units.

Besides, although operations of the present methods are described in a particular order in the drawings, it does not require or imply that these operations must be performed according to this particular sequence, or a desired outcome can only be achieved by performing all shown operations. On the contrary, the execution order for the steps as depicted in the flowcharts may be varied. Additionally or alternatively, some steps may be omitted, a plurality of steps may be merged into one step, and/or a step may be divided into a plurality of steps for execution.

Although the present invention has been depicted with reference to a plurality of embodiments, it should be understood that the present invention is not limited to the disclosed embodiments. On the contrary, the present invention intends to cover various modifications and equivalent arrangements included in the spirit and scope of the appended claims. The scope of the appended claims meets the broadest explanations and covers all such modifications and equivalent structures and functions.

What is claimed is:

1. A data protection method, comprising:
receiving at least one event prediction message from at least one message source, the at least one event prediction message being associated with an event that is predicted to occur in a future period of time;
analyzing information, which is relevant to the event, included in the at least one event prediction message, so as to determine a risk level of the event with respect to data to be protected; and
determining a data protection operation for the data to be protected at least based on the risk level and a predetermined event handling policy.

2. The method according to claim 1, wherein receiving at least one event prediction message from at least one message source comprises at least one of the following:
periodically receiving the at least one event prediction message from the at least one message source; and
receiving the at least one event prediction message in response to a push from the at least one message source.

3. The method according to claim 1, wherein the information related to the event comprises at least one of the following: type of the event, description of the event, predicted occurring time of the event, predicted lasting time or predicted end time of the event, and predicted impact scope of the event.

4. The method according to claim 1, wherein the information related to the event at least comprises predicted impact scope of the event, and the method further comprises:
automatically determining the data to be protected based on storage location of data and the predicted impact scope.

5. The method according to claim 1, further comprising:
parsing the information related to the event from the at least one event prediction message; and
normalizing the parsed information so as to be used for the analyzing.

6. The method according to claim 1, wherein analyzing information, which is relevant to the event, included in the at least one event prediction message, so as to determine a risk level of the event with respect to the data to be protected comprises:
querying a predetermined correlation between events and risk levels using the information related to the event; and
determining the risk level of the event based on the query.

7. The method according to claim 1, wherein determining a data protection operation for the data to be protected at least based on the risk level and a predetermined event handling policy comprises:
obtaining, for the data to be protected, metadata of an existing data protection plan which is temporally adjacent to or at least partially overlaps with the period; and
determining the data protection operation based on the risk level, the event handling policy, the information related to the event, and the metadata.

8. The method according to claim 7, wherein determining the data protection operation based on the risk level, the event handling policy, the information related to the event, and the metadata comprises:
modifying the event handling policy so as to avoid confliction with the existing data protection plan when determining the data protection operation.

9. The method according to claim 1, further comprising at least one of the following:
displaying to a user information related to the determined data protection operation;
displaying to a user the information related to the event; and
automatically executing the determined data protection operation.

10. The method according to any of claim 1, wherein the event comprises one of the following: a physical event in a real world, and a virtual event for the data to be protected.

11. A data protection system, comprising:
a receiving unit configured to receive at least one event prediction message from at least one message source, the at least one event prediction message being associated with an event that is predicted to occur in a future period of time;
an analyzing unit configured to analyze information, which is relevant to the event, included in the at least one event prediction message, so as to determine a risk level of the event with respect to data to be protected; and
a deciding unit configured to determine a data protection operation at least based on the risk level and a predetermined event handling policy.

12. The system according to claim 11, wherein the receiving unit comprises at least one of the following:
a first receiving unit configured to periodically receive the at least one event prediction message from the at least one message source; and
a second receiving unit configured to receive the at least one event prediction message in response to a push from the at least one message source.

13. The system according to claim 11, wherein the information related to the event comprises at least one of the following: type of the event, description of the event, predicted occurring time of the event, predicted lasting time or predicted end time of the event, and predicted impact scope of the event.

14. The system according to claim 11, wherein the information related to the event at least comprises predicted impact scope of the event, and the system further comprises:
a data determining unit configured to automatically determine the data to be protected based on storage location of data and the predicted impact scope.

15. The system according to claim 11, further comprising:
a message parsing unit configured to parse the information related to the event from the at least one event prediction message; and
a normalizing unit configured to normalize the parsed information so as to be used for the analyzing.

16. The system according to claim 11, wherein the analyzing unit comprises:
a correlation query unit configured to query a predetermined correlation between events and risk levels using the information related to the event; and
a level determining unit configured to determine the risk level of the event based on the query.

17. The system according to claim 11, wherein the deciding unit comprises:
a metadata obtaining unit configured to obtain, for the data to be protected, metadata of an existing data protection plan which is temporally adjacent to or at least partially overlaps with the period; and
a first deciding unit configured to determine the data protection operation based on the risk level, the event handling policy, the information related to the event, and the metadata.

18. The system according to claim 17, wherein the first deciding unit comprises:
a handling policy modifying unit configured to modify the event handling policy so as to avoid confliction with the existing data protection plan when determining the data protection operation.

19. The system according to claim 11, further comprising at least one of the following:
a first display unit configured to display to a user information related to the determined data protection operation;
a second display unit configured to display to a user the information related to the event; and
an executing unit configured to automatically execute the determined data protection operation.

20. The system according to any of claim 11, wherein the event comprises one of the following: a physical event in a real world, and a virtual event for the data to be protected.
